(19) United States
(12) Patent Application Publication
(10) Pub. No.: US 2024/0334120 A1
(43) Pub. Date: Oct. 3, 2024

(54) CIRCUMFERENTIAL WAVEGUIDE

(71) Applicant: Transom Post OpCo, LLC, Framingham, MA (US)

(72) Inventors: Scott Diehl, Marlborough, MA (US); Andrew Kyte, Cumberland, RI (US)

(21) Appl. No.: 18/620,272

(22) Filed: Mar. 28, 2024

Related U.S. Application Data
(60) Provisional application No. 63/455,005, filed on Mar. 28, 2023.

(51) Int. Cl. H04R 1/34

(52) U.S. Cl. CPC H04R 1/345

(57) ABSTRACT

Systems and methods are directed to a waveguide that includes an acoustic inlet, and acoustic conduit, and an acoustic outlet. The acoustic inlet receives acoustic energy from an acoustic transducer and the acoustic energy transits the acoustic conduit to the acoustic outlet. The acoustic conduit and the acoustic outlet are configured to distribute the acoustic energy to a listening zone without a primary axis, e.g., such that the acoustic energy is distributed about a range of the listening zone with consistent sound pressure levels.

### BACKGROUND

Typical ceiling and pendant speakers have a limited, conical radiation pattern. As a result, multiple units are required to cover large spaces adequately, translating to higher cost, longer installation time, more wire runs, and greater negative aesthetic impact. Conical and omnidirectional sources inherently suffer from a distance-based loss in sound pressure level (SPL), e.g., SPL drops off by the inverse of the distance (radius) as one transverses the listener plane (e.g., walking along the floor) and moves further off-axis. One solution is to mount-either externally or internally-multiple direct radiator transducers around the circumference of a single pendant, thereby providing substantially wider coverage. However, this solution requires multiple high frequency drivers. The beamwidth of these drivers varies with frequency and their radiation pattern approaches that of an omni-directional source in their lower frequency range so their beamwidth is not constant. Moreover, the use of multiple drivers with overlapping radiation patterns creates additional variation in acoustic coverage due to comb filtering.

### SUMMARY

Systems and methods disclosed herein are directed to circumferential, or partially circumferential, waveguides designed to distribute acoustic energy from an acoustic transducer (speaker) such that an energy distribution from the overall structure (speaker and waveguide, collectively a speaker assembly) is more uniformly distributed across a range of listening positions, such as when a listener walks along a hallway or through a room and passes underneath or near the speaker assembly, e.g., such as when the speaker assembly is mounted in or suspended from a ceiling.

Examples disclosed herein may be combined with other examples in any manner consistent with at least one of the principles disclosed herein, and references to “an example,” “some examples,” “an alternate example,” “various examples,” “one example or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1 is a perspective view of an example speaker assembly including a circumferential waveguide according to an embodiment; and

FIG. 2 is a is a cross-sectional schematic view of the speaker assembly of FIG. 1 including an optional low frequency driver (woofer).

### DETAILED DESCRIPTION

Aspects of the present disclosure are directed to systems and methods suitable for distributing acoustic energy in a consistent pattern over an intended listener space. More specifically, systems and methods herein are directed to a circumferential waveguide, or partially circumferential waveguide, to consistently direct acoustic energy across a range of locations in a listening zone across a range of frequencies.

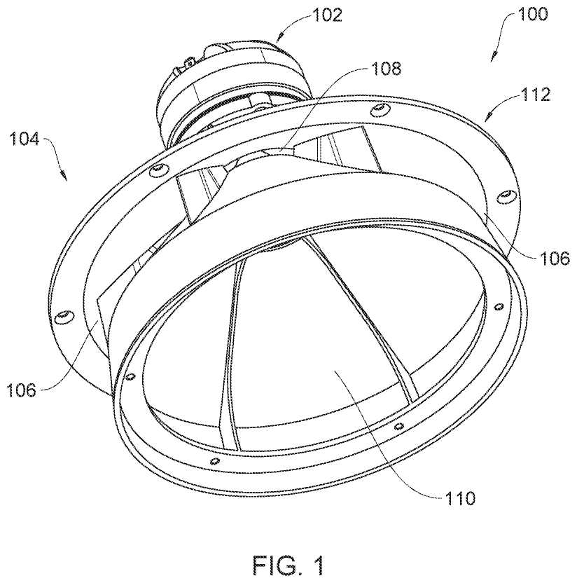

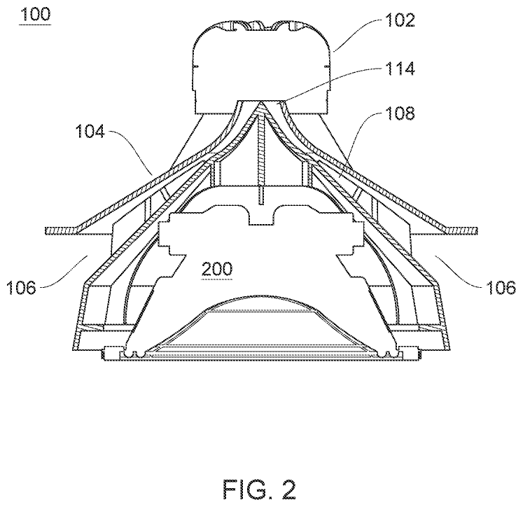

FIG. 1 illustrates one example of a speaker assembly 100 including an acoustic transducer 102, such as a compression driver, and a circumferential waveguide 104. The circumferential waveguide 104 includes an acoustic outlet 106 that goes around the entire circumference of the circumferential waveguide 104 and emits acoustic energy from an acoustic conduit 108. The acoustic energy is generated by the acoustic transducer 102 and fed to the acoustic conduit 108 through an acoustic inlet 114 (shown in FIG. 2). The example illustrated in FIG. 1 includes a void space 110, which may, in some examples, accommodate a low frequency transducer such as a woofer. An optional flange 112 is included that may be used for mounting the speaker assembly 100 to an enclosure, ceiling, etc.

FIG. 2 illustrates a cross-sectional view of the exemplary speaker assembly 100 that includes a woofer 200 mounted in the void space 110. In certain examples, the acoustic transducer 102 may be a mid to high frequency transducer to provide mid and high frequencies while the woofer 200 may produce lower frequencies. In such examples, the circumferential waveguide 100 distributes the mid and high frequencies substantially evenly all around the woofer 200 and in a direction that is not axially aligned with any of the acoustic transducer 102, the circumferential waveguide 100, or the woofer 200. An acoustic output of the acoustic outlet 106, in fact, substantially has no “on-axis” directional output. Instead, the acoustic output is distributed around a circular pattern (in this example) radiating away from the speaker assembly 100, unlike conventional horn or waveguide structures. Those of skill in the art will appreciate that FIG. 2 omits various components that may generally be included to incorporate the woofer 200, such as a back can or acoustic volume, a front baffle, porting between the woofer 200 and the back volume, etc.

According to various examples, a circumferential waveguide compensates for loss of sound pressure level (SPL) with increasing distance (radius, r) from the speaker assembly. In a conventional speaker assembly, such as a ceiling mounted or pendant speaker, SPL drops off with the inverse of the distance (1/r) as a listener moves off-axis, such as walking underneath and then away from the speaker. In contrast, speaker assemblies having a circumferential waveguide in accord with aspects and examples herein provide consistent coverage in a listener plane, e.g., the floor along which a listener moves.

In various examples, a speaker assembly with a circumferential waveguide may be pendant-mounted to radiate relatively downward into an occupied space. In other examples the speaker assembly may be flush mounted, while in other examples a semi-flush ceiling mount may be provided. When mounted facing downward, e.g., from a ceiling, the circumferential waveguide in accordance with those disclosed herein may distribute acoustic energy more horizontally and consistently around a range of directions than conventional ceiling-mount speakers.

According to some examples, a circumferential waveguide may span less than 360 degrees to provide coverage to a smaller sector. For example, the acoustic conduit and acoustic outlet may be structured to provide acoustic energy in ‘half’ the direction, such as 180 degrees. This style or design may be put into service at an edge of a room, for instance. In other examples, the acoustic conduit and acoustic outlet may be structured to provide a 90 degree or ‘quarter’ coverage, such as may be put into service at a corner of the room. In yet further examples, the acoustic conduit and acoustic outlet may be structured to provide direct acoustic energy in opposing directions, such as along a hallway wherein a listener would be anticipated to walk in a relatively straight line (forward and back) but not far to one side or the other, as the confines of the hallway would prevent a listener from being in such a zone. Further examples may include an acoustic conduit and acoustic outlet to provide other acoustic radiation patterns.

In some examples, a circumferential waveguide with full 360 degree coverage or less may provide options for occluding portions of the waveguide, or the acoustic outlet 106 to enable a user-selectable coverage.

In various examples, the circumferential waveguide may include perforations to allow other frequencies (those not directed by the waveguide) to pass through, such as from an internally mounted low frequency driver.

In some examples, a circumferential waveguide may include radially oriented, hollow supports to behave as acoustic ports.

Some examples of circumferential waveguides may include differing expansion rates around its circumference, e.g., from the acoustic inlet to the acoustic outlet, to direct more acoustic energy in certain directions than others, such as to generate a radiation pattern more suited for rectangular rooms or other shaped spaces. For example, to maintain a consistent SPL in all area of a rectangular room, more acoustic energy needs to be directed to the corners of the room.

Various examples of circumferential waveguides may include a non-circular circumference, such as to produce differing coverage shapes and/or to minimize reinforcement of waveforms directly underneath (in the case of ceiling or pendant mounted).

As illustrated in FIG. 2, some examples may include a low-frequency driver mounted coaxially in the external funnel of the waveguide, e.g., the void space 110.

In some cases, a manifolded design may be included to accommodate multiple high frequency drivers feeding a single circumferential waveguide.

Some example circumferential waveguides may include an acoustic lens at its mouth, e.g., the acoustic outlet.

Circumferential waveguides in accordance with those herein may, in some examples, include a waveguide shaped to provide various differing coverage orientations, such as left, right, center, from a single speaker assembly. In some examples, a circumferential waveguide may be coupled with an enclosure having multiple mid-low drivers oriented around a circumferential arc such that the mid-low acoustic output substantially aligns with that of the circumferential waveguide.

The improved consistency in acoustic radiation pattern achieved by a circumferential waveguide in accordance with those described herein is capable of providing coverage to a large space, thus reducing cost and installation time, and allowing the use of a single “home run” wiring scheme. Aesthetically, a single ceiling-mount or pendant is less obtrusive than multiple such speakers or a single speaker with multiple externally mounted drivers to provide the same coverage area. The use of the circumferential waveguide also provides more consistent control across the frequency band. The directionality of the circumferential waveguide allows a user to cover a large area while anchoring the sound, if desired, to a display or other source. Finally, because the circumferential waveguide is a circumferentially continuous source, it eliminates comb filtering effects observed with systems having multiple pendants or multiple drivers.

Circumferential waveguides in accord with those herein provides a waveguide shape having a mouth (acoustic outlet) along a surface like that of a conical annulus so that the “on-axis” goes from being on a single axis to being along a conical surface radiating outward “off-axis”. Furthermore, the off-axis response is meant to contribute to the planar response such that it remains consistent both directly under the unit and off-axis.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A waveguide comprising:
an acoustic inlet to receive acoustic energy from an acoustic transducer;
an acoustic outlet to emit the acoustic energy; and
an acoustic conduit to transfer the acoustic energy from the inlet to the outlet, wherein the acoustic conduit and the acoustic outlet are configured to distribute the acoustic energy to a listening zone without a primary axis.

2. The waveguide of claim 1, wherein at least three locations along a plane have equal sound pressure levels.

3. The waveguide of claim 1, wherein the acoustic outlet comprises a circular or semi-circular shape.

4. The waveguide of claim 1, wherein the acoustic outlet radially encompasses one of a 360-degree range, a 180-degree range, or a 90-degree range.

5. The waveguide of claim 1, wherein the acoustic outlet is configured to distribute a greater portion of the acoustic energy in selected directions.

6. The waveguide of claim 1, wherein the acoustic outlet is configured to have a user-configurable distribution of the acoustic energy.

7. The waveguide of claim 1, further comprising user-selectable locations to accommodate occluding members to provide a user-configurable distribution of the acoustic energy.

8. The waveguide of claim 1, wherein the waveguide is configured to produce the same sound pressure level (SPL) at three locations on a plane.

9. The waveguide of claim 1, wherein the waveguide is configured to produce the same SPL across multiple distances along a plane oriented perpendicular to an axis of the waveguide.

10. A speaker assembly comprising:
a waveguide in accordance with claim 1; and
wherein the acoustic transducer is coupled to the acoustic inlet.

11. The speaker assembly of claim 10, further comprising an enclosure to which the waveguide is secured.

12. The speaker assembly of claim 10, further comprising another acoustic transducer coupled to the waveguide or to the acoustic inlet.

13. A loudspeaker comprising:
a waveguide in accordance with claim 1; and
a second acoustic transducer coupled to the waveguide or to the acoustic inlet; and
an enclosure to which the loudspeaker is secured.
